(19) United States
(12) Patent Application Publication
(10) Pub. No.: US 2023/0004774 A1
(43) Pub. Date: Jan. 5, 2023

(54) METHOD AND APPARATUS FOR GENERATING NODE REPRESENTATION, ELECTRONIC DEVICE AND READABLE STORAGE MEDIUM

(71) Applicant: BEIJING BAIDU NETCOM SCIENCE TECHNOLOGY CO., LTD., Beijing (CN)

(72) Inventors: Weibin LI, Beijing (CN); Zhifan ZHU, Beijing (CN); Shikun FENG, Beijing (CN); Shiwei HUANG, Beijing (CN); Jingzhou HE, Beijing (CN)

(73) Assignee: BEIJING BAIDU NETCOM SCIENCE TECHNOLOGY CO., LTD., Beijing (CN)

(21) Appl. No.: 17/578,683

(22) Filed: Jan. 19, 2022

(30) Foreign Application Priority Data
Jun. 30, 2021 (CN) 202110732838.X

(51) Int. Cl. G06N 3/04; G06N 3/08

(52) U.S. Cl. CPC G06N 3/04; G06N 3/08

(57) ABSTRACT

The present disclosure provides a method and apparatus for generating a node representation, an electronic device and a readable storage medium, and relates to the field of deep learning technologies. The method for generating a node representation includes: acquiring a heterogeneous graph to be processed; performing a sampling operation in the heterogeneous graph to be processed according to a first meta path, so as to obtain at least one first walk path; obtaining an initial node representation of each node in the heterogeneous graph to be processed according to the at least one first walk path; and generating the final node representation of each node according to the initial node representation of each node and initial node representations of neighbor nodes of each node. With the present disclosure, accuracy of the generated node representation may be improved.

### CROSS-REFERENCE TO RELATED APPLICATIONS

The present application claims the priority of Chinese Patent Application No. 202110732838.X, filed on Jun. 30, 2021, with the title of “METHOD AND APPARATUS FOR GENERATING NODE REPRESENTATION, ELECTRONIC DEVICE AND READABLE STORAGE MEDIUM.” The disclosure of the above application is incorporated herein by reference in its entirety.

### TECHNICAL FIELD

The present disclosure relates to the field of computer technologies, and particularly to the field of deep learning technologies, and provides a method and apparatus for generating a node representation, an electronic device and a readable storage medium.

### BACKGROUND

Currently, graph network representations may be used for a variety of downstream tasks, including node classification, link prediction, community detection, or the like. In the real world, there exist a large number of heterogeneous graphs, and the heterogeneous graphs contain various node types and edge types. In order to learn semantic information of different types of nodes, a method usually adopted in a prior art includes: performing a sampling operation according to a defined meta path to obtain different walk paths, and training the walk paths using training methods, such as word2vec, or the like, so as to finally obtain a representation result of the node in the heterogeneous graph. In this node representation learning method, only one meta path is considered, information of other meta paths may be lost, and accuracy of a node representation may be affected due to noise (wrongly connected edges between nodes).

### SUMMARY

According to a first aspect of the present disclosure, there is provided a method for generating a node representation, including: acquiring a heterogeneous graph to be processed; performing a sampling operation in the heterogeneous graph to be processed according to a first meta path, so as to obtain at least one first walk path; obtaining an initial node representation of each node in the heterogeneous graph to be processed according to the at least one first walk path; and generating the final node representation of each node according to the initial node representation of each node and initial node representations of neighbor nodes of each node.

According to a second aspect of the present disclosure, there is provided an electronic device, including: at least one processor; and a memory communicatively connected with the at least one processor; wherein the memory stores instructions executable by the at least one processor, and the instructions are executed by the at least one processor to enable the at least one processor to perform a method for generating a node representation, wherein the method includes: acquiring a heterogeneous graph to be processed; performing a sampling operation in the heterogeneous graph to be processed according to a first meta path, so as to obtain at least one first walk path; obtaining an initial node representation of each node in the heterogeneous graph to be processed according to the at least one first walk path; and generating the final node representation of each node according to the initial node representation of each node and initial node representations of neighbor nodes of each node.

According to a third aspect of the present disclosure, there is provided anon-transitory computer readable storage medium with computer instructions stored thereon, wherein the computer instructions are used for causing a computer to perform a method for generating a node representation, wherein the method includes: acquiring a heterogeneous graph to be processed; performing a sampling operation in the heterogeneous graph to be processed according to a first meta path, so as to obtain at least one first walk path; obtaining an initial node representation of each node in the heterogeneous graph to be processed according to the at least one first walk path; and generating the final node representation of each node according to the initial node representation of each node and initial node representations of neighbor nodes of each node.

From the above technical solution, it is observed that, in the present embodiment, after the sampling operation is performed in the heterogeneous graph to be processed according to the first preset meta path to obtain the at least one first walk path, the initial node representation of each node in the heterogeneous graph to be processed is first obtained according to the at least one first walk path obtained by the sampling operation, and the final node representation of each node is then generated according to the initial node representations of each node and the neighbor nodes thereof, such that information of the neighbor nodes may be fused in the final node representation of each node, thus improving accuracy of the generated final node representation.

It should be understood that the statements in this section are not intended to identify key or critical features of the embodiments of the present disclosure, nor limit the scope of the present disclosure. Other features of the present disclosure will become apparent from the following description.

### BRIEF DESCRIPTION OF THE DRAWINGS

The drawings are used for better understanding the present solution and do not constitute a limitation of the present disclosure. In the drawings,

FIG. 1 is a schematic diagram according to a first embodiment of the present disclosure;

FIG. 2 is a schematic diagram according to a second embodiment of the present disclosure;

FIG. 3 is a schematic diagram according to a third embodiment of the present disclosure;

FIG. 4 is a schematic diagram according to a fourth embodiment of the present disclosure; and

FIG. 5 is a block diagram of an electronic device configured to implement a method for generating a node representation according to the embodiment of the present disclosure.

### DETAILED DESCRIPTION

The following part will illustrate exemplary embodiments of the present disclosure with reference to the drawings, including various details of the embodiments of the present disclosure for a better understanding. The embodiments should be regarded only as exemplary ones. Therefore, those skilled in the art should appreciate that various changes or modifications can be made with respect to the embodiments described herein without departing from the scope and spirit of the present disclosure. Similarly, for clarity and conciseness, the descriptions of the known functions and mechanisms are omitted in the descriptions below.

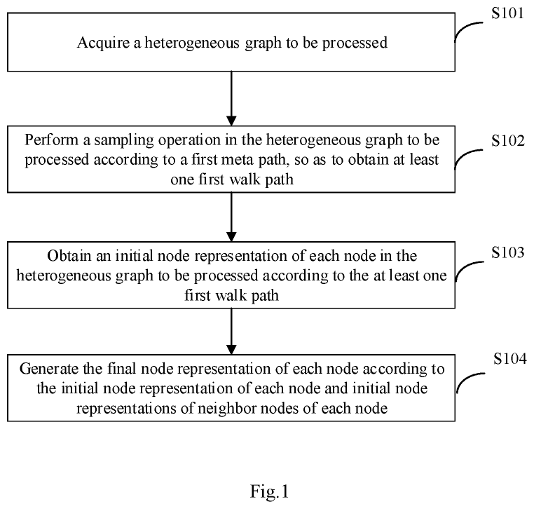

FIG. 1 is a schematic diagram according to a first embodiment of the present disclosure. As shown in FIG. 1, a method for generating a node representation according to the present embodiment may include the following steps:

S101: acquiring a heterogeneous graph to be processed;

S102: performing a sampling operation in the heterogeneous graph to be processed according to a first preset meta path, so as to obtain at least one first walk path;

S103: obtaining an initial node representation of each node in the heterogeneous graph to be processed according to the at least one first walk path; and

S104: generating the final node representation of each node according to the initial node representation of each node and initial node representations of neighbor nodes of each node.

In the method for generating a node representation according to the present embodiment, after the sampling operation is performed in the heterogeneous graph to be processed according to the first preset meta path to obtain the at least one first walk path, the initial node representation of each node in the heterogeneous graph to be processed is first obtained according to the at least one first walk path obtained by the sampling operation, and the final node representation of each node is then generated according to the initial node representations of each node and the neighbor nodes thereof, such that information of the neighbor nodes may be fused in the final node representation of each node, thus improving accuracy of the generated final node representation.

In the present embodiment, during execution of the S101 of acquiring a heterogeneous graph to be processed, the heterogeneous graph to be processed may be selected according to different downstream tasks, the obtained heterogeneous graph to be processed includes different types of nodes and edges between the nodes, and the edge between two nodes represents a connection relationship between the two nodes.

For example, if the downstream task is a news recommendation task, the to-be-processed heterogeneous graph obtained by executing the S101 in the present embodiment may be a graph network composed of a news node, a user node, and an interest node.

In the present embodiment, after the execution of the S101 of acquiring a heterogeneous graph to be processed, the S102 of performing a sampling operation in the acquired heterogeneous graph to be processed according to a first meta path, so as to obtain at least one first walk path is executed.

The first meta path in the present embodiment may be preset according to a structure of the heterogeneous graph to be processed and the downstream task for which the heterogeneous graph to be processed is used, and the first meta path contains the specified node type and the connection relationship between the nodes.

For example, if the heterogeneous graph to be processed includes three types of nodes of B (news), U (user), and A (interest); the first meta path 1 used to execute the S102 in the present embodiment may be U-B-U (user-news-user) for describing a relationship that a piece of news is clicked by two users; the used first meta path 2 may be U-A-U for describing a relationship that two users have a same interest. It is clear that when the sampling operation is performed in the heterogeneous graph to be processed according to different first meta paths, the obtained first walk paths corresponding to the different first meta paths have different semantic information.

It may be understood that, in the present embodiment, during the execution of the S102, the sampling operation may be performed according to one first metal path to obtain at least one first walk path, or according to plural first meta paths to obtain plural first walk paths.

In the present embodiment, during the execution of the S102 of performing a sampling operation in the heterogeneous graph to be processed according to a first meta path, so as to obtain at least one first walk path, an optional implementation which may be adopted includes: performing the sampling operation in the heterogeneous graph to be processed according to the node type specified based on each first meta path and the connection relationship between the nodes, so as to obtain the at least one first walk path corresponding to the first meta path.

In the present embodiment, during the execution of the S102, the sampling operation may be performed in the heterogeneous graph to be processed based on a random walk strategy, so as to obtain the first walk path corresponding to each first meta path.

For example, if the nodes included in the heterogeneous graph to be processed are U1, U2, U3, B1, B2, B3, B4, A1, A2, A3, and A4, if the first meta path 1 is U-B-U, the first walk path obtained by the sampling operation according to the first meta path 1 in the heterogeneous graph to be processed may be U1-B2-U2-B4-U3, and the first walk path may also be U2-B3-U3-B2-U1; if the first meta path 2 is U-A-U, the first walk path obtained by the sampling operation according to the first meta path 2 in the heterogeneous graph to be processed may be U1-A2-U2-A4-U3.

In the present embodiment, after the S102 is executed to obtain the at least one first walk path, the S103 of obtaining an initial node representation of each node in the heterogeneous graph to be processed according to the obtained at least one first walk path is executed.

In the present embodiment, during the execution of the S103 of obtaining an initial node representation of each node in the heterogeneous graph to be processed according to the at least one first walk path, each obtained first walk path may be directly input to a neural network model obtained by a pre-training operation, and the initial node representation of each node in the heterogeneous graph to be processed is obtained by the neural network model according to the edges between the nodes of each type in the input first walk path.

In the present embodiment, after the S103 is executed to obtain the initial node representation of each node in the heterogeneous graph to be processed, the S104 of generating the final node representation of each node according to the initial node representation of each node and initial node representations of neighbor nodes of each node is executed.

Before the execution of the S104 of generating the final node representation of each node according to the initial node representation of each node and initial node representations of neighbor nodes of each node, the method according to the present embodiment may further include: for each node, taking, as the neighbor nodes of the node, the nodes in the heterogeneous graph to be processed which are a preset distance away from the node, and if the preset distance is 1, taking the nodes 1 away from the current node as the neighbor nodes of the current node in the present embodiment.

In the present embodiment, during the execution of the S104, a weighted summation may be directly performed on the initial node representation of each node and the initial node representations of the neighbor nodes of each node, such that the obtained weighted summation result is used as the final node representation of each node.

Specifically, in the present embodiment, during the execution of the S104 of generating the final node representation of each node according to the initial node representation of each node and initial node representations of neighbor nodes of each node, an optional implementation which may be adopted includes: performing the weighted summation on the initial node representation of each node and the initial node representations of the neighbor nodes of each node, and taking the obtained weighted summation result as an updated node representation of each node; after the initial node representation of each node is replaced with the updated node representation, proceeding to the step of performing the weighted summation on the initial node representation of each node and the initial node representations of the neighbor nodes of each node until a preset number of times is reached; taking, as the final node representation of each node, the updated node representation of each node when the preset number of times is reached.

In the present embodiment, during the execution of the S104, when the weighted summation is performed on the initial node representation of each node and the initial node representations of the neighbor nodes of each node, the following computational formula may be used:

H^{(k+1)}=αÂh^{k}+(1−α)H^{k}

In the formula, H^{(k+1)} represents the updated node representation of the current node at the (k+1)th weighted summation; α denotes a weight coefficient having a value ranging from 0 to 1; Â represents an adjacency matrix; h^{k} represents the updated node representation of the neighbor node of the current node at the kth weighted summation; H^{k} represents the updated node representation of the current node at the kth weighted summation.

That is, in the present embodiment, aggregation is performed on each node and the neighbor node corresponding to each node in the heterogeneous graph to be processed, and the initial node representation of each node is updated plural times, such that the obtained final node representation of each node includes the information of the neighbor node, thus further improving the accuracy of the obtained final node representation.

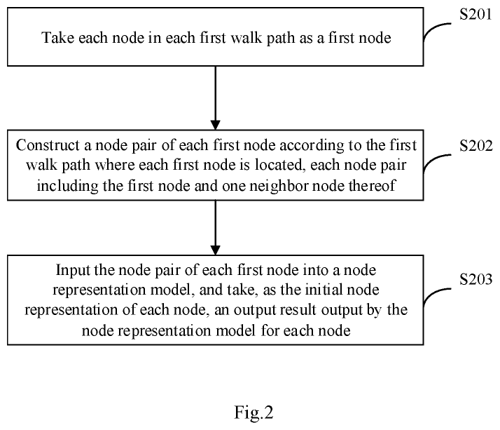

FIG. 2 is a schematic diagram according to a second embodiment of the present disclosure. As shown in FIG. 2, in the present embodiment, the S103 of obtaining an initial node representation of each node in the heterogeneous graph to be processed according to the at least one first walk path may include the following steps:

S201: taking each node in each first walk path as a first node;

S202: constructing a node pair of each first node according to the first walk path where each first node is located, each node pair including the first node and one neighbor node thereof; and

S203: inputting the node pair of each first node into a node representation model, and taking, as the initial node representation of each node, an output result output by the node representation model for each node.

In the present embodiment, during the execution of the S103 of obtaining an initial node representation of each node according to the first walk path, after the construction of the node pair corresponding to each node, each node pair is processed by the node representation model obtained by a pre-training operation, so as to obtain the initial node representation of each node.

In the present embodiment, during execution of the S202 of constructing a node pair of each first node according to the first walk path where each first node is located, an optional implementation which may be adopted includes: for each first node, in the first walk path where the first node is located, determining at least one neighbor node of the first node, for example, taking a node located at a preset distance before and/or after the current node as the neighbor node of the current node; and obtaining the node pair of the first node according to the first node and one neighbor node thereof.

The node representation model used in the execution of the S203 in the present embodiment is obtained by the pre-training operation, and the node representation model may output the initial node representation of each node according to the input node pair corresponding to the node.

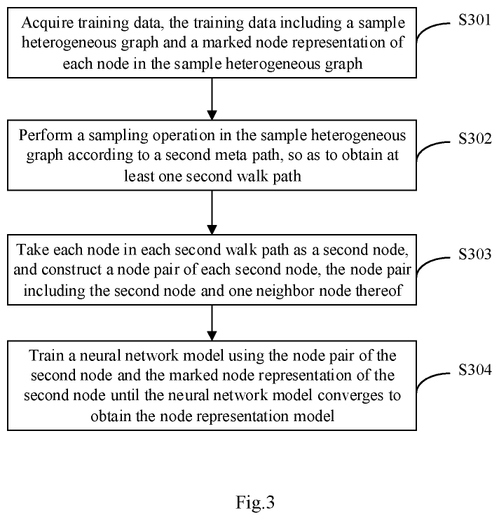

FIG. 3 is a schematic diagram according to a third embodiment of the present disclosure. As shown in FIG. 3, the node representation model used in the execution of the S203 in the present embodiment is obtained by the pre-training operation by:

S301: acquiring training data, the training data including a sample heterogeneous graph and a marked node representation of each node in the sample heterogeneous graph;

S302: performing a sampling operation in the sample heterogeneous graph according to a second meta path, so as to obtain at least one second walk path;

S303: taking each node in each second walk path as a second node, and constructing a node pair of each second node, the node pair including the second node and one neighbor node thereof; and

S304: training a neural network model using the node pair of the second node and the marked node representation of the second node until the neural network model converges to obtain the node representation model.

The second meta path used in the execution of the S302 in the present embodiment may be the same as or different from the first meta path.

The process of executing the S302 of performing a sampling operation to obtain at least one second walk path in the present embodiment is similar to the process of executing the S102 of performing a sampling operation to obtain at least one first walk path in the foregoing embodiment, and is not repeated herein.

The process of executing the S303 of constructing a node pair of the second node in the present embodiment is similar to the process of executing the S202 of constructing a node pair of the first node in the foregoing embodiment, and is not repeated herein.

In the present embodiment, during execution of the S304 of training a neural network model using the node pair of the second node and the marked node representation of the second node until the neural network model converges, an optional implementation which may be adopted includes: inputting the node pair of the second node into the neural network model to obtain an output result output by the neural network model for the node pair, the neural network model used in the present embodiment being a walk class diagram learning model; and updating parameters in the neural network model according to a loss function value calculated according to the obtained output result and the marked node representation of the second node until the neural network model converges.

The node representation model obtained by the training operation in the present embodiment may output the node representation of the node according to the input node pair of the node.

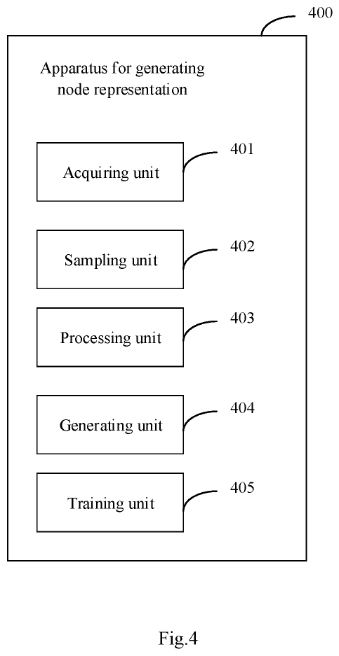

FIG. 4 is a schematic diagram according to a fourth embodiment of the present disclosure. As shown in FIG. 4, an apparatus 400 for generating a node representation according to the present embodiment includes: an acquiring unit 401 configured to acquire a heterogeneous graph to be processed; a sampling unit 402 configured to perform a sampling operation in the heterogeneous graph to be processed according to a first preset meta path, so as to obtain at least one first walk path; a processing unit 403 configured to obtain an initial node representation of each node in the heterogeneous graph to be processed according to the at least one first walk path; and a generating unit 404 configured to generate the final node representation of each node according to the initial node representation of each node and initial node representations of neighbor nodes of each node.

When acquiring the heterogeneous graph to be processed, the acquiring unit 401 may select the heterogeneous graph to be processed according to different downstream tasks, the obtained heterogeneous graph to be processed includes different types of nodes and edges between the nodes, and the edge between two nodes represents a connection relationship between the two nodes.

In the present embodiment, after the acquiring unit 401 acquires the heterogeneous graph to be processed, the sampling unit 402 performs the sampling operation in the acquired heterogeneous graph to be processed according to the first meta path, so as to obtain the at least one first walk path.

It may be understood that the sampling unit 402 may perform the sampling operation according to one first metal path to obtain at least one first walk path, or according to plural first meta paths to obtain plural first walk paths.

When performing the sampling operation in the heterogeneous graph to be processed according to the first meta path, so as to obtain the at least one first walk path, in an optional implementation which may be adopted, the sampling unit 402 performs the sampling operation in the heterogeneous graph to be processed according to the node type specified based on each first meta path and the connection relationship between the nodes, so as to obtain the at least one first walk path corresponding to the first meta path.

The sampling unit 402 may perform the sampling operation in the heterogeneous graph to be processed based on a random walk strategy, so as to obtain the first walk path corresponding to each first meta path.

In the present embodiment, after the at least one first walk path is obtained by the sampling unit 402, the processing unit 403 obtains the initial node representation of each node in the heterogeneous graph to be processed according to the obtained at least one first walk path.

When obtaining the initial node representation of each node in the heterogeneous graph to be processed according to the at least one first walk path, the processing unit 403 may directly input each obtained first walk path to a neural network model obtained by a pre-training operation, and the initial node representation of each node in the heterogeneous graph to be processed is obtained by the neural network model according to the edges between the nodes of each type in the input first walk path.

When obtaining the initial node representation of each node in the heterogeneous graph to be processed according to the at least one first walk path, in an optional implementation which may be adopted, the processing unit 403 may take each node in each first walk path as a first node; construct a node pair of each first node according to the first walk path where each first node is located, each node pair including the first node and one neighbor node thereof; and input the node pair of each first node into a node representation model, and take, as the initial node representation of each node, an output result output by the node representation model for each node.

When constructing the node pair of each first node according to the first walk path where each first node is located, in an optional implementation which may be adopted, the processing unit 403 may, for each first node, in the first walk path where the first node is located, determine at least one neighbor node of the first node; and obtain the node pair of the first node according to the first node and one neighbor node thereof.

The node representation model used by the processing unit 403 is obtained by the pre-training operation by a training unit 405, and the node representation model may output the initial node representation of each node according to the input node pair corresponding to the node.

The apparatus 400 for generating a node representation according to the present embodiment may further include the training unit 405 configured to perform the pre-training operation to obtain the node representation model by: acquiring training data, the acquired training data including a sample heterogeneous graph and a marked node representation of each node in the sample heterogeneous graph; performing a sampling operation in the acquired sample heterogeneous graph according to a second meta path, so as to obtain at least one second walk path; taking each node in each second walk path as a second node, and constructing a node pair of each second node, the constructed node pair including the second node and one neighbor node thereof; and training a neural network model using the node pair of the second node and the marked node representation of the second node until the neural network model converges to obtain the node representation model.

The second meta path used by the training unit 405 may be the same as or different from the first meta path used by the sampling unit 402.

The process of performing the sampling operation to obtain the at least one second walk path by the training unit 405 is similar to the process of performing the sampling operation to obtain the at least one first walk path by the sampling unit 402, and is not repeated herein.

The process of constructing the node pair of the second node by the training unit 405 is similar to the process of constructing the node pair of the first node by the processing unit 403, and is not repeated herein.

When training the neural network model using the node pair of the second node and the marked node representation of the second node until the neural network model converges, in an optional implementation which may be adopted, the training unit 405: inputs the node pair of the second node into the neural network model to obtain an output result output by the neural network model for the node pair, the neural network model used in the present embodiment being a walk class diagram learning model; and updates parameters in the neural network model according to a loss function value calculated according to the obtained output result and the marked node representation of the second node until the neural network model converges.

In the present embodiment, after the processing unit 403 obtains the initial node representation of each node in the heterogeneous graph to be processed, the generating unit 404 generates the final node representation of each node according to the initial node representation of each node and the initial node representations of the neighbor nodes of each node.

Before generating the final node representation of each node according to the initial node representation of each node and the initial node representations of the neighbor nodes of each node, the generating unit 404 may: for each node, take, as the neighbor nodes of the node, the nodes in the heterogeneous graph to be processed which are a preset distance away from the node.

The generating unit 404 may directly perform a weighted summation on the initial node representation of each node and the initial node representations of the neighbor nodes of each node, such that the obtained weighted summation result is used as the final node representation of each node.

Specifically, when generating the final node representation of each node according to the initial node representation of each node and the initial node representations of the neighbor nodes of each node, in an optional implementation which may be adopted, the generating unit 404: performs the weighted summation on the initial node representation of each node and the initial node representations of the neighbor nodes of each node, and takes the obtained weighted summation result as an updated node representation of each node; after the initial node representation of each node is replaced with the updated node representation, proceeds to the step of performing the weighted summation on the initial node representation of each node and the initial node representations of the neighbor nodes of each node until a preset number of times is reached; takes, as the final node representation of each node, the updated node representation of each node when the preset number of times is reached.

In the technical solution of the present disclosure, the acquisition, storage and application of involved user personal information are in compliance with relevant laws and regulations, and do not violate public order and good customs.

According to the embodiment of the present disclosure, there are also provided an electronic device, a readable storage medium and a computer program product.

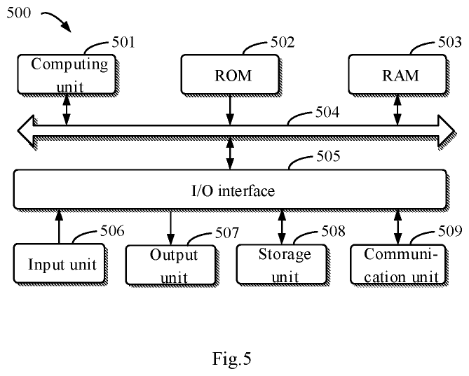

FIG. 5 is a block diagram of an electronic device for the method for generating a node representation according to the embodiment of the present disclosure. The electronic device is intended to represent various forms of digital computers, such as laptop computers, desktop computers, workstations, personal digital assistants, servers, blade servers, mainframe computers, and other appropriate computers. The electronic device may also represent various forms of mobile apparatuses, such as personal digital assistants, cellular telephones, smart phones, wearable devices, and other similar computing apparatuses. The components shown herein, their connections and relationships, and their functions, are meant to be exemplary only, and are not meant to limit implementation of the present disclosure described and/or claimed herein.

As shown in FIG. 5, the device 500 includes a computing unit 501 which may perform various appropriate actions and processing operations according to a computer program stored in a read only memory (ROM) 502 or a computer program loaded from a storage unit 508 into a random access memory (RAM) 503. Various programs and data necessary for the operation of the device 500 may be also stored in the RAM 503. The computing unit 501, the ROM 502, and the RAM 503 are connected with one other through a bus 504. An input/output (I/O) interface 505 is also connected to the bus 504.

The plural components in the device 500 are connected to the I/O interface 505, and include: an input unit 506, such as a keyboard, a mouse, or the like; an output unit 507, such as various types of displays, speakers, or the like; the storage unit 508, such as a magnetic disk, an optical disk, or the like; and a communication unit 509, such as a network card, a modem, a wireless communication transceiver, or the like. The communication unit 509 allows the device 500 to exchange information/data with other devices through a computer network, such as the Internet, and/or various telecommunication networks.

The computing unit 501 may be a variety of general and/or special purpose processing components with processing and computing capabilities. Some examples of the computing unit 501 include, but are not limited to, a central processing unit (CPU), a graphic processing unit (GPU), various dedicated artificial intelligence (AI) computing chips, various computing units running machine learning model algorithms, a digital signal processor (DSP), and any suitable processor, controller, microcontroller, or the like. The computing unit 501 performs the methods and processing operations described above, such as the method for generating a node representation. For example, in some embodiments, the method for generating a node representation may be implemented as a computer software program tangibly contained in a machine readable medium, such as the storage unit 508.

In some embodiments, part or all of the computer program may be loaded and/or installed into the device 500 via the ROM 502 and/or the communication unit 509. When the computer program is loaded into the RAM 503 and executed by the computing unit 501, one or more steps of the method for generating a node representation described above may be performed. Alternatively, in other embodiments, the computing unit 501 may be configured to perform the method for generating a node representation by any other suitable means (for example, by means of firmware).

Various implementations of the systems and technologies described herein may be implemented in digital electronic circuitry, integrated circuitry, field programmable gate arrays (FPGA), application specific integrated circuits (ASIC), application specific standard products (ASSP), systems on chips (SOC), complex programmable logic devices (CPLD), computer hardware, firmware, software, and/or combinations thereof. The systems and technologies may be implemented in one or more computer programs which are executable and/or interpretable on a programmable system including at least one programmable processor, and the programmable processor may be special or general, and may receive data and instructions from, and transmit data and instructions to, a storage system, at least one input apparatus, and at least one output apparatus.

Program codes for implementing the method according to the present disclosure may be written in any combination of one or more programming languages. These program codes may be provided to a processor or a controller of a general purpose computer, a special purpose computer, or other programmable data processing apparatuses, such that the program code, when executed by the processor or the controller, causes functions/operations specified in the flowchart and/or the block diagram to be implemented. The program code may be executed entirely on a machine, partly on a machine, partly on a machine as a stand-alone software package and partly on a remote machine, or entirely on a remote machine or a server.

In the context of the present disclosure, the machine readable medium may be a tangible medium which may contain or store a program for use by or in connection with an instruction execution system, apparatus, or device. The machine readable medium may be a machine readable signal medium or a machine readable storage medium. The machine readable medium may include, but is not limited to, an electronic, magnetic, optical, electromagnetic, infrared, or semiconductor system, apparatus, or device, or any suitable combination of the foregoing. More specific examples of the machine readable storage medium may include an electrical connection based on one or more wires, a portable computer disk, a hard disk, a random access memory (RAM), a read only memory (ROM), an erasable programmable read only memory (EPROM or flash memory), an optical fiber, a portable compact disc read only memory (CD-ROM), an optical storage device, a magnetic storage device, or any suitable combination of the foregoing.

To provide interaction with a user, the systems and technologies described here may be implemented on a computer having: a display apparatus (for example, a cathode ray tube (CRT) or liquid crystal display (LCD) monitor) for displaying information to a user; and a keyboard and a pointing apparatus (for example, a mouse or a trackball) by which a user may provide input for the computer. Other kinds of apparatuses may also be used to provide interaction with a user; for example, feedback provided for a user may be any form of sensory feedback (for example, visual feedback, auditory feedback, or tactile feedback); and input from a user may be received in any form (including acoustic, speech or tactile input).

The systems and technologies described here may be implemented in a computing system (for example, as a data server) which includes a back-end component, or a computing system (for example, an application server) which includes a middleware component, or a computing system (for example, a user computer having a graphical user interface or a web browser through which a user may interact with an implementation of the systems and technologies described here) which includes a front-end component, or a computing system which includes any combination of such back-end, middleware, or front-end components. The components of the system may be interconnected through any form or medium of digital data communication (for example, a communication network). Examples of the communication network include: a local area network (LAN), a wide area network (WAN) and the Internet.

A computer system may include a client and a server. Generally, the client and the server are remote from each other and interact through the communication network. The relationship between the client and the server is generated by virtue of computer programs which run on respective computers and have a client-server relationship to each other. The server may be a cloud server, also called a cloud computing server or a cloud host, and is a host product in a cloud computing service system, so as to overcome the defects of high management difficulty and weak service expansibility in conventional physical host and virtual private server (VPS) service. The server may also be a server of a distributed system, or a server incorporating a blockchain.

It should be understood that various forms of the flows shown above may be used and reordered, and steps may be added or deleted. For example, the steps described in the present disclosure may be executed in parallel, sequentially, or in different orders, which is not limited herein as long as the desired results of the technical solution disclosed in the present disclosure may be achieved.

The above-mentioned implementations are not intended to limit the scope of the present disclosure. It should be understood by those skilled in the art that various modifications, combinations, sub-combinations and substitutions may be made, depending on design requirements and other factors. Any modification, equivalent substitution and improvement made within the spirit and principle of the present disclosure all should be included in the extent of protection of the present disclosure.

What is claimed is:

1. A method for generating a node representation, comprising:
acquiring a heterogeneous graph to be processed;
performing a sampling operation in the heterogeneous graph to be processed according to a first meta path, so as to obtain at least one first walk path;
obtaining an initial node representation of each node in the heterogeneous graph to be processed according to the at least one first walk path; and
generating the final node representation of each node according to the initial node representation of each node and initial node representations of neighbor nodes of each node.

2. The method according to claim 1, wherein the performing a sampling operation in the heterogeneous graph to be processed according to a first meta path, so as to obtain at least one first walk path comprises:
performing the sampling operation in the heterogeneous graph to be processed according to a node type specified based on each first meta path and a connection relationship between nodes, so as to obtain the at least one first walk path corresponding to the first meta path.

3. The method according to claim 1, wherein the obtaining an initial node representation of each node in the heterogeneous graph to be processed according to the at least one first walk path comprises:
taking each node in each first walk path as a first node;
constructing a node pair of each first node according to the first walk path where each first node is located, each node pair comprising the first node and one neighbor node thereof; and
inputting the node pair of each first node into a node representation model, and taking, as the initial node representation of each node, an output result output by the node representation model for each node.

4. The method according to claim 3, further comprising: performing a pre-training operation to obtain the node representation model by:
acquiring training data, the training data comprising a sample heterogeneous graph and a marked node representation of each node in the sample heterogeneous graph;
performing a sampling operation in the sample heterogeneous graph according to a second meta path, so as to obtain at least one second walk path;
taking each node in each second walk path as a second node, and constructing a node pair of each second node, the node pair comprising the second node and one neighbor node thereof; and
training a neural network model using the node pair of the second node and the marked node representation of the second node until the neural network model converges to obtain the node representation model.

5. The method according to claim 1, wherein the generating the final node representation of each node according to the initial node representation of each node and initial node representations of neighbor nodes of each node comprises:
performing a weighted summation on the initial node representation of each node and the initial node representations of the neighbor nodes of each node, and taking the obtained weighted summation result as an updated node representation of each node;
after the initial node representation of each node is replaced with the updated node representation, proceeding to the step of performing a weighted summation on the initial node representation of each node and the initial node representations of the neighbor nodes of each node until a preset number of times is reached; and
taking, as the final node representation of each node, the updated node representation of each node when the preset number of times is reached.

6. An electronic device, comprising:
at least one processor; and
a memory communicatively connected with the at least one processor;
wherein the memory stores instructions executable by the at least one processor, and the instructions are executed by the at least one processor to enable the at least one processor to perform a method for generating a node representation, wherein the method comprises:
acquiring a heterogeneous graph to be processed;
performing a sampling operation in the heterogeneous graph to be processed according to a first meta path, so as to obtain at least one first walk path;
obtaining an initial node representation of each node in the heterogeneous graph to be processed according to the at least one first walk path; and
generating the final node representation of each node according to the initial node representation of each node and initial node representations of neighbor nodes of each node.

7. The electronic device according to claim 6, wherein the performing a sampling operation in the heterogeneous graph to be processed according to a first meta path, so as to obtain at least one first walk path comprises:
performing the sampling operation in the heterogeneous graph to be processed according to a node type specified based on each first meta path and a connection relationship between nodes, so as to obtain the at least one first walk path corresponding to the first meta path.

8. The electronic device according to claim 6, wherein the obtaining an initial node representation of each node in the heterogeneous graph to be processed according to the at least one first walk path comprises:
taking each node in each first walk path as a first node;
constructing a node pair of each first node according to the first walk path where each first node is located, each node pair comprising the first node and one neighbor node thereof; and
inputting the node pair of each first node into a node representation model, and taking, as the initial node representation of each node, an output result output by the node representation model for each node.

9. The electronic device according to claim 8, further comprising: performing a pre-training operation to obtain the node representation model by:
acquiring training data, the training data comprising a sample heterogeneous graph and a marked node representation of each node in the sample heterogeneous graph;
performing a sampling operation in the sample heterogeneous graph according to a second meta path, so as to obtain at least one second walk path;
taking each node in each second walk path as a second node, and constructing a node pair of each second node, the node pair comprising the second node and one neighbor node thereof; and
training a neural network model using the node pair of the second node and the marked node representation of the second node until the neural network model converges to obtain the node representation model.

10. The electronic device according to claim 6, wherein the generating the final node representation of each node according to the initial node representation of each node and initial node representations of neighbor nodes of each node comprises:
performing a weighted summation on the initial node representation of each node and the initial node representations of the neighbor nodes of each node, and taking the obtained weighted summation result as an updated node representation of each node;
after the initial node representation of each node is replaced with the updated node representation, proceeding to the step of performing a weighted summation on the initial node representation of each node and the initial node representations of the neighbor nodes of each node until a preset number of times is reached; and
taking, as the final node representation of each node, the updated node representation of each node when the preset number of times is reached.

11. A non-transitory computer readable storage medium with computer instructions stored thereon, wherein the computer instructions are used for causing a computer to perform a method for generating a node representation, wherein the method comprises:
acquiring a heterogeneous graph to be processed;
performing a sampling operation in the heterogeneous graph to be processed according to a first meta path, so as to obtain at least one first walk path;
obtaining an initial node representation of each node in the heterogeneous graph to be processed according to the at least one first walk path; and
generating the final node representation of each node according to the initial node representation of each node and initial node representations of neighbor nodes of each node.

12. The non-transitory computer readable storage medium according to claim 11, wherein the performing a sampling operation in the heterogeneous graph to be processed according to a first meta path, so as to obtain at least one first walk path comprises:
performing the sampling operation in the heterogeneous graph to be processed according to a node type specified based on each first meta path and a connection relationship between nodes, so as to obtain the at least one first walk path corresponding to the first meta path.

13. The non-transitory computer readable storage medium according to claim 11, wherein the obtaining an initial node representation of each node in the heterogeneous graph to be processed according to the at least one first walk path comprises:
taking each node in each first walk path as a first node;
constructing a node pair of each first node according to the first walk path where each first node is located, each node pair comprising the first node and one neighbor node thereof; and
inputting the node pair of each first node into a node representation model, and taking, as the initial node representation of each node, an output result output by the node representation model for each node.

14. The non-transitory computer readable storage medium according to claim 13, further comprising: performing a pre-training operation to obtain the node representation model by:
acquiring training data, the training data comprising a sample heterogeneous graph and a marked node representation of each node in the sample heterogeneous graph;
performing a sampling operation in the sample heterogeneous graph according to a second meta path, so as to obtain at least one second walk path;
taking each node in each second walk path as a second node, and constructing a node pair of each second node, the node pair comprising the second node and one neighbor node thereof; and
training a neural network model using the node pair of the second node and the marked node representation of the second node until the neural network model converges to obtain the node representation model.

15. The non-transitory computer readable storage medium according to claim 11, wherein the generating the final node representation of each node according to the initial node representation of each node and initial node representations of neighbor nodes of each node comprises:
performing a weighted summation on the initial node representation of each node and the initial node representations of the neighbor nodes of each node, and taking the obtained weighted summation result as an updated node representation of each node;
after the initial node representation of each node is replaced with the updated node representation, proceeding to the step of performing a weighted summation on the initial node representation of each node and the initial node representations of the neighbor nodes of each node until a preset number of times is reached; and
taking, as the final node representation of each node, the updated node representation of each node when the preset number of times is reached.
